(19) United States
(12) Patent Application Publication
(10) Pub. No.: US 2024/0005259 A1
(43) Pub. Date: Jan. 4, 2024

(54) INDEX MODELING

(71) Applicant: ACCENTURE GLOBAL SOLUTIONS LIMITED, Dublin 4 (IE)

(72) Inventors: Ajay VASAL, Bangalore (IN); Robert GIMENO FEU, Barcelona (ES); Siddharth Narain SINGH, Haryana (IN); Ghanshyam DEVNANI, BENGALURU (IN); Nadine TUPAIKA, Barcelona (ES); Poppy Elizabeth Mary BREWER, London (GB); Venkatesh Venkatesh CG, Mumbai (IN); Amar DEEP BEHERA, Pune (IN); Omkar H. PAWASKAR, Thane West (IN); Ajay Kumar ROUTH, West Bengal (IN)

(73) Assignee: ACCENTURE GLOBAL SOLUTIONS LIMITED, Dublin 4 (IE)

(21) Appl. No.: 18/093,437

(22) Filed: Jan. 5, 2023

(30) Foreign Application Priority Data
Jun. 29, 2022 (EP) 22382612.4

(51) Int. Cl. G06Q 10/08; G06Q 10/067; G06Q 10/0635

(52) U.S. Cl. CPC G06Q 10/08; G06Q 10/067; G06Q 10/0635

(57) ABSTRACT

An index modeling system that generates index models that predict values of an attribute of a supply chain for a commodity is disclosed. The index models are generated from indicator data that includes data related to multiple indicators and a plurality of sub-indicators of the index arranged in a hierarchical structure. Accordingly, the index values can be predicted for different entities at different levels in the hierarchical structure. The predicted index values can be used to automatically generate a filtered list of suppliers who can be used for procurement based on comparisons of the predicted attribute values of the suppliers with a predetermined attribute threshold value.

### PRIORITY

The present application claims priority under 35 U.S.C. 119(a)-(d) to the European Patent Application Serial No. 22382612.4, having a filing date of Jun. 29, 2022, the disclosure of which is hereby incorporated by reference in its entirety.

### BACKGROUND

Mathematical models employed as machine learning (ML) models produce outputs based on data patterns. An ML algorithm is provided with training data to learn from and to produce an ML model which is further incorporated into various computer systems to execute different functions. The training data contains the correct answer, which is known as a target variable or target attribute. The learning algorithm finds patterns in the training data that map the input data attributes to the target (the answer that is to be predicted), and an ML model is produced that captures these patterns. ML models have found innumerable applications across various domains that include not only scientific and commercial domains but are also being applied in the field of social sciences to identify patterns and make predictions regarding social trends which in turn increase the accuracy of computing systems when used in various applications.

### BRIEF DESCRIPTION OF DRAWINGS

Features of the present disclosure are illustrated by way of examples shown in the following figures. In the following figures, like numerals indicate like elements, in which:

FIG. 1 shows a diagram of an index modeling system in accordance with the examples disclosed herein.

FIG. 2 shows a block diagram of a data processor in accordance with the examples disclosed herein.

FIG. 3 shows a block diagram of a model generator in accordance with the examples disclosed herein.

FIG. 4 shows a block diagram of a data analyzer in accordance with the examples disclosed herein.

FIG. 5 shows a block diagram of an index-based supplier processor in accordance with the examples disclosed herein.

FIG. 6A shows a flowchart of a process to obtain values or scores for a supporting index in accordance with the examples disclosed herein.

FIG. 6B includes a flowchart of a process to obtain the scores for the target index in accordance with the examples disclosed herein.

FIG. 6C shows a flowchart of a method of training the index models in accordance with the examples disclosed herein.

FIG. 7 shows a flowchart that details a method of analyzing the index model outputs in accordance with the examples disclosed herein.

FIG. 8 shows a flowchart for obtaining forecasts for index values based on time series models in accordance with the examples disclosed herein.

FIG. 9 shows a flowchart of a method of identifying entities that do not meet thresholds for the various indexes in accordance with the examples disclosed herein.

FIG. 10A shows some example insights that can be generated by an insight generator in accordance with the examples disclosed herein.

FIG. 10B shows a heat map generated in accordance with the examples disclosed herein.

FIG. 11 illustrates a computer system that may be used to implement the index modeling system in accordance with the examples disclosed herein.

### DETAILED DESCRIPTION

For simplicity and illustrative purposes, the present disclosure is described by referring to examples thereof. In the following description, numerous specific details are set forth in order to provide a thorough understanding of the present disclosure. It will be readily apparent however that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

### 1. Overview

An index modeling system is disclosed which provides an index model that predicts attribute values for an index. The index represents an attribute of a supply chain of a commodity. Various indexes can be generated that are representative of different attributes of the supply chain for one or more environmental, social, and/or governance (ESG) factors. The index model is trained on indicator data which includes data associated with a hierarchical structure of entities which can include a commodity entity, a country entity, a supplier entity, etc. The indicator data can include data regarding multiple indexes or indicators. The different indexes can be analyzed via corresponding index models. However, the indexes may be interdependent so that one of the indexes can be affected by other indexes. Accordingly, when one of the indexes is being predicted, the other indexes are treated as indicators (model inputs) for the index (model output) under processing and the factors affecting each of the indicators are treated as sub-indicators of the indicators.

The indicator data can be accessed from different data sources in different formats. The indicator data from the different data sources can be converted into a uniform format. A master file is generated including the converted indicator data. At least one index model representative of one of the indexes associated with the supply chain is generated and trained on the indicator data. In an example, a single index model may be generated at the commodity level for predicting the attribute values for the entire supply chain so that all the entities have the same attribute value at a specified time. However, according to one example, the indicator data can be partitioned country-wise, and different index models can be trained for different countries so that a specific index model predicts the values of the index for a specified country. The values predicted for the country may be applied to entities below the country level in the hierarchical structure e.g., the supplier entity. Alternately, index models may also be generated for individual suppliers within a country if there is sufficient data regarding the supplier. A subset of the indicators may be selected which are correlated with the index and for each of the indicators, a correlated subset of the plurality of sub-indicators may be further selected for generating the index model. In an example, the index model may include a multiple linear regression model with the index as the target variable and the filtered indicators as explanatory variables. The predicted attribute values thus generated can be presented in different formats including data visualizations.

The predicted attribute values from the index model can be used within a material management system to filter suppliers of a commodity. In an example, the predicted values from the index model are compared with a predetermined threshold attribute value and only suppliers who clear the predetermined threshold attribute value are filtered and presented for procurement. In an example, a filtered list of suppliers can be generated by deleting one or more of a plurality of suppliers whose predicted attribute values do not match the predetermined threshold attribute value. The filtered list of suppliers can be transmitted to subscribers who have registered with the material management system to receive such notifications. Alternatively, the index modeling system can be a part of the material management system so that one or more of the suppliers can be assessed under the various ESG indices and a database of suppliers who comply with the standards can be maintained so that whenever a requirement arises, the ESG-compliant supplier database can be consulted for procurement.

If the predicted values for a country do not clear the threshold, the suppliers who caused the country to fail may be isolated using, for example, the individual supplier models. Alternately or additionally, the indicator data can be analyzed further to determine the reasons for the failure. The index modeling system is further configured to obtain the feature importance of the various indicators/sub-indicators for a specified index. The feature importance can be indicative of the extent of contribution of a particular feature to the index or sensitivity of the index to the feature. Additionally, a time-series analysis can be applied to the index to obtain future forecasts from existing indicator data without having to collect and process the additional feature data.

The computational methodology generally implemented for modeling an index follows a bottom-to-top approach wherein sub-indicators for a particular index for a commodity are collated to compute the indicator values using predefined weights. However, such methodology includes certain drawbacks such as subjective weights which may be assigned by human users. As a result, certain sub-indicators have relatively higher weights than others for parent indicator derivation and the indicator values are averaged from its sub-indicator risk scores. Therefore, the true effect of an indicator remains unknown or is too complex to determine. To overcome this scenario, the predicted index values or risk scores are provided across different hierarchies characterized by different attributes. Only indicators that clear certain correlation thresholds are selected for predicting the index values thereby reducing the complexity. Moreover, the feature importance scores are computed and used to identify important features which can justify the risk scores/attribute values predicted for a given entity. Thus, instead of a black-box ML model, the index models described herein provide explainable results as the index models are based on well-defined indicators/sub-indicators that can be individually analyzed.

The predicted values can be used to improve material management systems which when configured with the index modeling as described herein are enabled to estimate and track the ESG index scores for various entities. In an example, the index modeling system enables updating a supplier database with suppliers who follow the standards for the various indexes. For example, ESG risk scores can be obtained for countries, commodities, and suppliers by the index modeling system using sub-indicators, indicators from Maplecroft, Macroeconomic indicators from Census and Economic Information Center (CEIC), etc. Instead of a vendor-specified risk index, index scores are estimated for future implementations by identifying redundant features (if present) using multicollinearity. Notifications to entities such as suppliers can be automatically generated based on the feature importance scores.

### 2. System Architecture

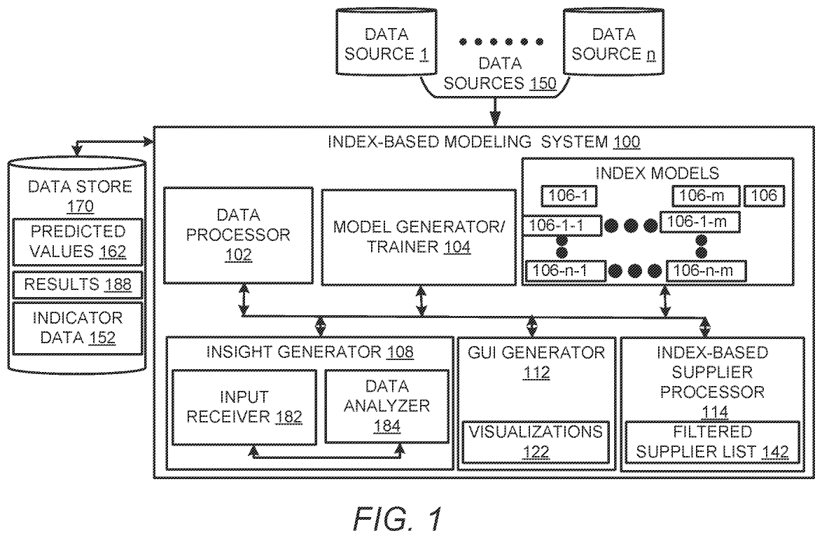

FIG. 1 shows a diagram of an index modeling system 100 in accordance with the examples disclosed herein. The index modeling system 100 includes a data processor 102 that processes indicator data 152 from a plurality of data sources 150 such as data source 1, . . . , data source n, etc. The indicator data 152 is used by the model generator/trainer 104 to train at least one index model 106-1-1 that predicts attribute values for an index that is indicative of at least one attribute of a supply chain of a commodity. By way of illustration and not limitation, the index model 106-1-1 can predict values for the child labor index (CLI) in a supply chain for a commodity e.g., sugar so that entities such as suppliers engaging in child labor can be identified and avoided. The index modeling system 100 together with an index-based supplier processor 114, therefore, provides for a material management system that enables filtering out suppliers who may fail to meet criteria for certain attributes represented by various indexes to generate a filtered list of suppliers 142 from who the commodity may be procured. The index modeling system 100 also includes an insight generator 108 that employs the index model 106-1-1 to generate various results/insights 188 which can be provided to users by the GUI generator 112. The results 188 may not only include outputs or the predicted values 162 provided directly by the index model 106-1-1 but may also include data obtained by further processing the model outputs.

The indicator data 152 which may include global data pertaining to the supply chain of the commodity may include a hierarchical structure of entities in the supply chain such as a supplier entity, a corporation entity, a country entity, a region entity, a product entity (where the commodity is used), etc. In an example, the commodity entity is at the highest level of the hierarchical structure, the country/region entity at the mid-level or forms an intermediate level of the hierarchical structure while the supplier entity is at the lowest level of the hierarchical structure. Thus, the indicator data 152 for a supply chain for a given commodity would include the values for different indexes for all the entities in the hierarchical structure of that supply chain. In an example, the index values may be simple averages of the sub-indicator values. The hierarchical structure includes an arrangement of entities wherein data related to one entity is a subset of data of another entity higher up in the hierarchy. For example, data for suppliers can be contained in the data for a country or a region. Thus, different indexes may be representing different attributes of the supply chain. Examples of attributes represented by the indexes may include but are not limited to, child labor, decent wages, discrimination in the workplace, occupational health and safety, etc. It can be appreciated that these attributes or indexes can be interdependent so that one index may be an indicator for another index. For example, the index for decent wages may be an indicator of discrimination in the workplace, etc.

Various index models including 106, 106-1, . . . , 106-m (wherein m is natural numbers and m=1, 2, 3, . . . ) can be employed for obtaining the different indexes for all the entities associated with the supply chain of one commodity. In an example, ‘m’ can represent the number of indexes and ‘n’ can represent the number of entities. Accordingly, the index model 106 can be configured for predicting values for one index for all the entities in the hierarchy of a commodity supply chain. In an example, the indexes can include one or more of the Environment, Social, and Governance (ESG) indexes. By way of illustration and not limitation the plurality of data sources 150 can include Maplecroft which comprises twenty ESG risk scores for five commodities distributed among 198 countries. Accordingly, the data sources 150 can include data for the multiple indexes that represent various factors impacting the environmental, social, and governance aspects of a company or a country. In an example, each of the indexes can be calculated from 19-39 indicators.

In an example, data pertaining to one country and one index e.g., data pertaining to the child labor index for India can be accessed from one or more of the plurality of data sources 150 by the data processor 102 for the generation of the index model 106-1-1. Accordingly, the index model 106 can provide predictions for CLI for a given commodity for all the entities, thereby enabling a procurement department to identify and mitigate the risk of child labor in a multitier supply chain. The index model 106 can be generated based on a particular subset of the data selected from the plurality of data sources 150 that are indicative of the usage of child labor in a supply chain. In an example, the index model 106 can include a linear regression model with child labor index (CLI) as the target and the filtered indicators data as explanatory variables. For example, indexes for decent wages, decent working hours, forced labor, workplace discrimination, occupational health and safety, migrant labor, etc., can be considered explanatory variables or indicators. The accuracy of the index model 106 can be estimated using various methods such as but not limited to, root mean square error (RMSE), Mean Absolute Error, Mean Squared Error, etc. However, for many ESG indexes, it was determined from experimentation that independent models for different countries produce the most accurate results as the factors affecting the ESG indexes tend to be localized. Therefore, predicted values 162 output by the index model 106-1-1 for a given attribute and a given entity e.g., CLI/child labor risk score data for an entity thus obtained can be used by the insight generator 108 which provides insights into different aspects of child labor for the selected country. In an example, the user inputs can be received by the GUI generator 112 from various information screens. Similarly, data can be obtained and one or more of the index models 106-1-1, . . . , 106-n-m generated for various entities/groupings, e.g., countries, suppliers, etc., included in the Maplecroft database for a given commodity/supply chain. The index modeling system 100 can be coupled to a data storage 170 for storing different data required during its operations.

In an example, the insight generator 108 includes an input receiver 182, and a data analyzer 184. The input receiver 182 receives user input regarding specific insights to be generated. For example, the user may desire to investigate the hierarchical architecture in a supply chain that contributes to child labor risk. The data analyzer 184 receives the user input of a choice of commodity, country, supplier, etc., via, for example, a graphical user interface (GUI) and may execute an analysis wherein the data can be grouped and summarized across the supply chain hierarchy based on different variables to emphasize and reveal the relationships or connections between the commodities, country, suppliers, etc. In an example, the process of receiving the user input and generating data visualizations in response to the user input can occur in real time. For example, drill-down views encompassing entire supply chains can be generated by the GUI generator 112 to pinpoint the child labor risk footprints in terms of commodities, countries, and suppliers. Important nodes along with recurring patterns associated with the child labor risk across the supply chain can be identified from the GUIs. The results 188 can be displayed as networked graphs or in tabular forms. In addition, the insight generator 108 may also be configured for producing forecasts based on time series analysis.

The results 188 can also be employed to execute certain automatic tasks within the index modeling system 100 or another external system e.g., a material management/procurement system. One of the automatic tasks can include filtering suppliers based on specific criteria characterized by an index. For example, user input requesting a list of suppliers who comply with the standards for the various ESG factors can be received. Accordingly, the index modeling system 100 can be communicatively coupled to the index-based supplier processor 114 which can identify suppliers based on one or more indexes. In an example, the process for filtering the suppliers can be identified based on the Corporate Social Responsibility (CSR) implementations by enabling company-level, annual ESG scores. Similarly, other ESG factors can be indexed, modeled, and applied as filters. In an example, the index can be a CLI, and the index modeling system 100 includes an index-based supplier processor 114 that can identify and flag or even filter out suppliers who deal in child labor. Similarly, different thresholds for different indexes can be implemented by the index-based supplier processor 114. Therefore, if the results 188 including the CLI indicate that the risk of child labor is higher than the corresponding threshold, the index-based supplier processor 114 can flag the particular risky supplier. In an example, the index-based supplier processor 114 may be configured to generate a filtered supplier list 142 wherein risky suppliers are automatically removed from the list of available suppliers. In an example, notifications regarding the removal of the risky supplier and the reasons for the removal can be transmitted to receivers such as personnel registered with the index modeling system 100 to receive such notifications. Although the index-based supplier processor 114 is shown as being within the index modeling system 100, it can be appreciated that the index-based supplier processor 114 may also be implemented outside of the index modeling system 100 as part of an external material management or procurement system.

Other insights such as the cause-and-effect relationships can be discovered using the index model 106 by identifying important features/indicators for each index as detailed herein. For example, the data analyzer 184 can be configured to determine the importance of the various features (i.e., indicators and sub-indicators) of a given index or supply chain attribute being analyzed. If the attribute values predicted by the corresponding index model fail to meet thresholds/standards, then the importance of the various features can be obtained to explore the reasons for the failure of the index/attribute to meet standards. Reasons for the failure or areas for suggesting improvements can also be generated based on the feature's importance. The index models 106, 106-1, 106-1-1, . . . 106-2, . . . , 106-n-m, therefore, function not merely as black boxes but provide explainable results that enable entities to improve index scores.

In addition to generating different data visualizations 122, the updates and the feedback received from the various sources by the index modeling system 100 can be used by the model generator/trainer 104 as feedback for improving the index model 106-1-1. In an example, the feedback regarding the accuracy of the index models 106, 106-1, 106-1-1, . . . 106-2, . . . , 106-n-m, can be incorporated by the model generator/trainer 104 for improving the model outputs. Also, one or more of the plurality of data sources such as data source 1, . . . , data source n, etc. can be updated periodically, e.g., quarterly. When the new data becomes available, the model generator/trainer 104 can further train one or more of the index models 106, 106-1, 106-1-1, . . . 106-2, . . . , 106-n-m, on the new data. Similarly, for outputs produced by the index model 106-1-1 directly as results 188 or indirectly as the filtered supplier list 142, feedback can be received from the users for the direct and indirect outputs. Both positive and negative feedback regarding the outputs can be recorded, for example, in the data store 170, and used to generate new training data which is used to update/fine-tune the index model 106-1-1 via further training on the new training data. Therefore, the index models 106, 106-1, 106-1-1, . . . 106-2, . . . , 106-n-m, are responsive to changing circumstances and user preferences.

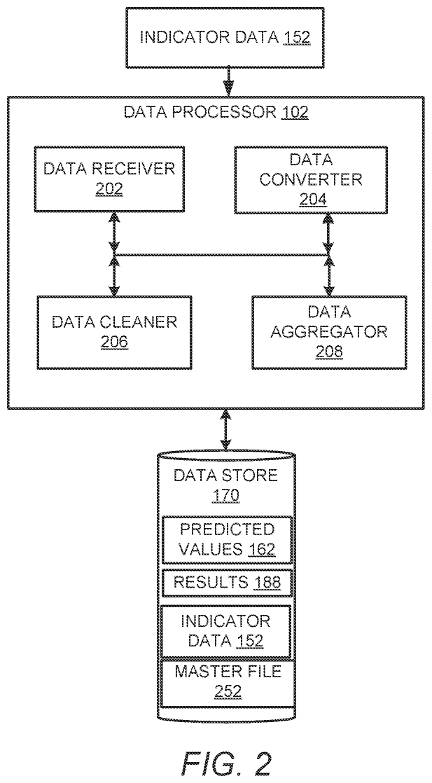

FIG. 2 shows a block diagram of the data processor 102 in accordance with the examples disclosed herein. The data processor 102 includes a data receiver 202, a data converter 204, a data cleaner 206, and a data aggregator 208. The data receiver 202 accesses the indicator data 152 from one or more of the plurality of data sources 150. In an example, only a subset of the plurality of data sources 150 may be initially accessed depending on the requirements of the index calculations. In an example, the indicator data 152 may be pushed to the index modeling system 100 as new data becomes available at any of the plurality of data sources 150. Alternately, the indicator data 152 may be pulled by the data receiver 202 periodically. For an example, one of the plurality of data sources 150 may include the Maplecroft data, and the indicator data 152 obtained may comprise data of 20 ESG risk scores for 198 countries and 5 commodities. The Maplecroft data may contain a large number of input features for each ESG index such as Forced Labor, Decent Labor varying across commodities, countries, and suppliers. The data from different ones of the plurality of data sources 150 may be received in different formats including structured and unstructured formats. The data converter 204 may convert the data into a single format. The data cleaner 206 cleans the received data to remove blank columns, blank rows, duplicate data, watermarks, and other noise. In an example, the indicator data 152 may also be collated by the data aggregator 208 into a master file 252 e.g., a flat file such as a spreadsheet or a database file, etc. The data thus collated may be separated based on index-criteria e.g., various indexes/indicators/sub-indicators, commodity criteria e.g., various commodities, temporal criteria such as year, quarter, etc., or other entity-related criteria such as on the basis of countries, regions suppliers, etc. The data may be labeled with the appropriate criteria names. New columns for including data, not in the indicator data 152 such as computed values, collated values, etc. may be included within the master file 252.

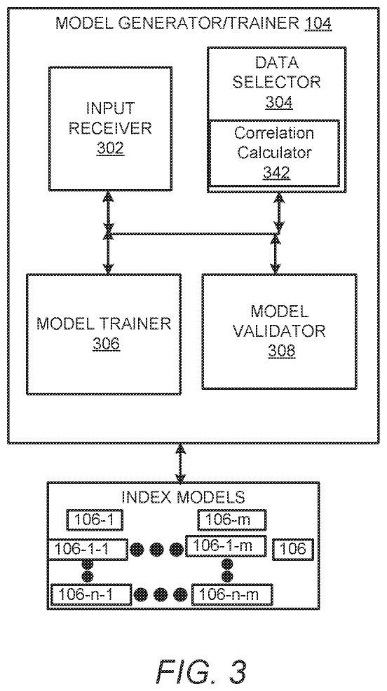

FIG. 3 shows a block diagram of the model generator/trainer 104 in accordance with the examples disclosed herein. The model generator/trainer 104 includes an input receiver 302, a data selector 304, a model trainer 306, and a model validator 312. The model generator/trainer 104 can be configured to generate multiple index models that predict values for different indexes/indicators for different entities in the hierarchical structure. The index model 106 may be one of the multiple index models predicting values for a target index which is obtained based on other supporting indexes or indicators for which the values may be obtained using other index models. In an example, a country may be the entity highest in the hierarchical structure of the indicator data 152, and different index models 106, 106-1, 106-1-1, . . . 106-1-m, can predict values for different indexes for one country. Accordingly, the input receiver 302 can be configured to receive input specifying a country/index and/or a supplier/index combination for which values are to be calculated.

The data selector 304 can be programmed to select appropriate data from the master file 252 based on the index model to be generated. In an example, one or more of the indicators are selected for obtaining the index model 106 based on their distributions. For example, for the generation of the CLI values, the correlation of the indicators (i.e., supporting indexes) with the CLI was calculated by the correlation calculator 342 using Pearson's Correlation Coefficient, and nine out of the ten indicators were found to correlate with CLI. Accordingly, nine ESG index models e.g., 106-1, . . . , 106-9, are generated by the model selector 306, and nine ESG index values are estimated using 10-37 sub-indicators for each indicator thus reducing the complexity in obtaining the CLI values. The model trainer 306 can be configured to split the appropriate data selected by the data selector 304 into training data and test data. In an example, the model trainer 306 can train an ML model based on multiple linear regression methodology on the training data with the index to be obtained as the target variable and the filtered indicators/sub-indicators as explanatory variables. A robust CLI may be thus obtained using estimated 9 ESG indexes with their macro-indicators as features for the countries. Accordingly, the data selector 304 selects the values predicted for the nine ESG indexes by the various index models for a given country in addition to other indicators/sub-indicator data from the master file 252 to generate the index model 106-1-1 that predicts the CLI values. Again, the model selector 306 may implement a multiple linear regression model for the index model 106 with CLI as the target variable and the filtered indexes, indicators/sub-indicators as explanatory variables. The model validator 308 validates the various models based on their accuracy. In an example, the model validator 308 can use the RMSE method to validate the index models 106, 106-1, . . . , 106-n.

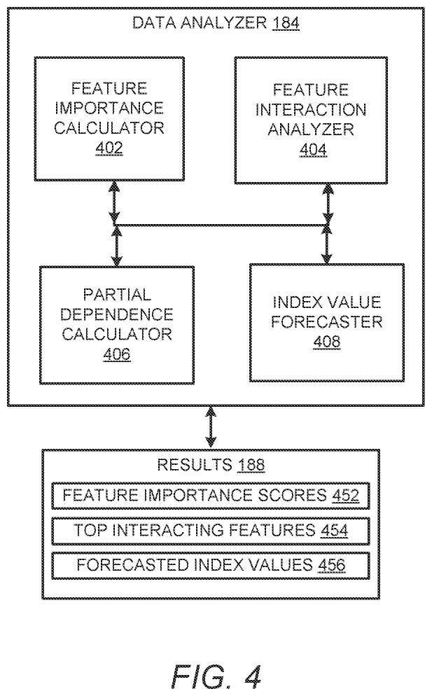

FIG. 4 shows a block diagram of the data analyzer 184 in accordance with the examples disclosed herein. The data analyzer 184 is configured with a feature importance calculator 402, a feature interaction analyzer 404 to identify factors that, together have a greater influence on the value of the index, and a partial dependence calculator 406 that identifies partial dependence of features on each other while interacting to influence the index. The data analyzer 184 also includes an index value forecaster 408, which generates time-based forecasts for index values. The outputs of the data analyzer 184 can be employed by the index-based supplier processor 114 to identify suppliers who implement ESG norms in keeping with the industry standards for procurement.

The feature importance calculator 402 can calculate feature importance scores 452 and identify the most important features affecting a particular index. In an example, the random forest model can be used for the calculation of feature importance. The feature interaction analyzer 404 can be configured to compute feature interaction using, for example, the minimal depth interaction function. Again, the top interacting features 454 are identified using values of the minimal depth interaction function. The partial dependence of the important features is determined by the partial dependence calculator 406 which is programmed to compute such partial dependencies The feature interaction analyzer 404 can also identify the influence of each feature between countries depending on the quantile distribution of the index values. While the partial dependency plots from the partial dependence calculator 406 enable determining the nature of the relationship between a feature and the index (e.g., linearity or non-linearity), the feature interaction analyzer 404 can quantify the effects of a feature all along an index distribution e.g., child labor distribution using quantile regression.

In an example, the indicator data 152 can be refreshed quarterly i.e., every 3 months. The index models 106, 106-1, 106-1-1, . . . 106-2, . . . , 106-n-m, can be refreshed accordingly. However, if predictions for the attribute values are required meanwhile, they can be obtained via time series analysis since the indicator data 152 is time series data. The index value forecaster 408 forecasts index values, i.e., forecasted index values 456 based on time series analysis. In an example, the index value forecaster 408 may analyze patterns of index values over a time period e.g., 18 quarters for a given commodity. Time series methodology is adopted for the forecasts as it mitigates the need to obtain updated values for all the features (i.e., indicators/sub-indicators) of the index. For example, the index value forecaster 408 can employ an Auto Regressive Integrated Moving Average (ARIMA) model for producing forecasts.

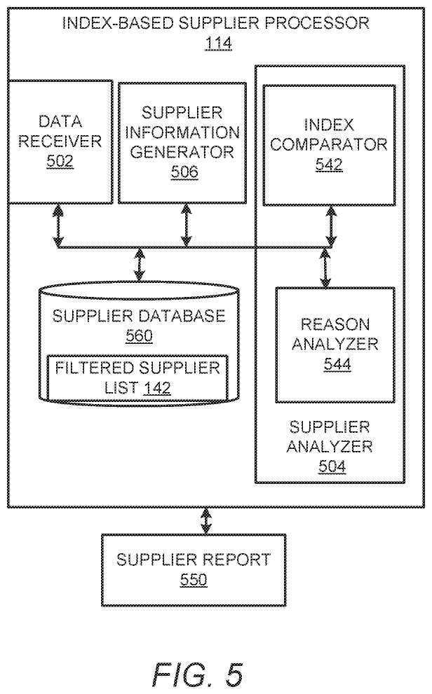

FIG. 5 shows a block diagram of the index-based supplier processor 114 in accordance with the examples disclosed herein. The index-based supplier processor 114 can include a data receiver 502, a supplier analyzer 504, and a supplier information generator 506. In an example, the index-based supplier processor 114 may include or may be communicatively coupled to a supplier database 560. Whenever an index relevant to a supply chain is generated and analyzed as detailed herein, it can trigger the index-based supplier processor 114 to evaluate the affected suppliers. For example, when a forced labor index of a country is generated or updated, the suppliers from that country can be re-evaluated by the index-based supplier processor 114 based on the new data. An updated version of the filtered supplier list 142 can be generated and provided to subscribers.

The data receiver 502 receives data regarding the results 188 including the predicted values 162 for the index. In an example, the results 188 may also include the relevant entities (i.e., countries, suppliers, commodities, etc.), associated with the various index values/scores. The supplier analyzer 504 includes an index comparator 542 and a reason analyzer 544. For a given entity, the index comparator 542 can compare the index values to a predetermined threshold attribute value accepted as standard across the supply chain for that commodity. If the entity meets the industry standard, then the entity (e.g., supplier) can be cleared for the index and may be included in the filtered supplier list 142 as eligible for procurement. If the entity fails to meet the standard the entity may be dropped from the filtered supplier list 142 and hence will be ineligible for procurement. In an example, an entity may have to clear standards for more than one index in order to be considered for procurement.

The supplier information generator 506 accesses information from the reason analyzer 544 to generate entity reports such as supplier report(s) 550 for one or more suppliers based on their performance with the important features/indicators. For an entity higher up in the hierarchy, such as a country, further analysis may be required depending on the position of the entity in the hierarchical structure within the indicator data 152. Thus, the index models 106, 106-1, 106-1-1, . . . 106-2, . . . , 106-n-m, do not merely function as black boxes. Rather, their outputs or the results 188 can be analyzed to determine the reasons why such index values are generated. If a supplier is cleared for procurement, then the outputs of the index models of the supplier pertaining to the indicators associated with the important features may be included in the supplier reports 550. When an entity fails to meet the predetermined threshold attribute value, the reason analyzer 544 accesses the feature importance scores 452 and the top interacting features 454 to determine reasons for the failure. In an example, one or more of the features with the highest importance scores (e.g., top N features where N is a natural number) can be identified as areas of concern for the entity in a supplier report 550. Additionally, the forecasted index values 456 for entities can also be used to flag entities that are on the verge of failing to meet the standards, and supplier reports may be generated if the entity is a supplier even as the supplier is included in the filtered supplier list 142. The supplier database 560 may be updated with the suppliers from the filtered supplier list 142. In an example, a stored procedure can be executed periodically to update the supplier database 560. Alternately each time the filtered supplier list 142 is generated, a trigger to update the supplier database can be fired based at least on the generation of the filtered supplier list 142.

### 3. Flowcharts

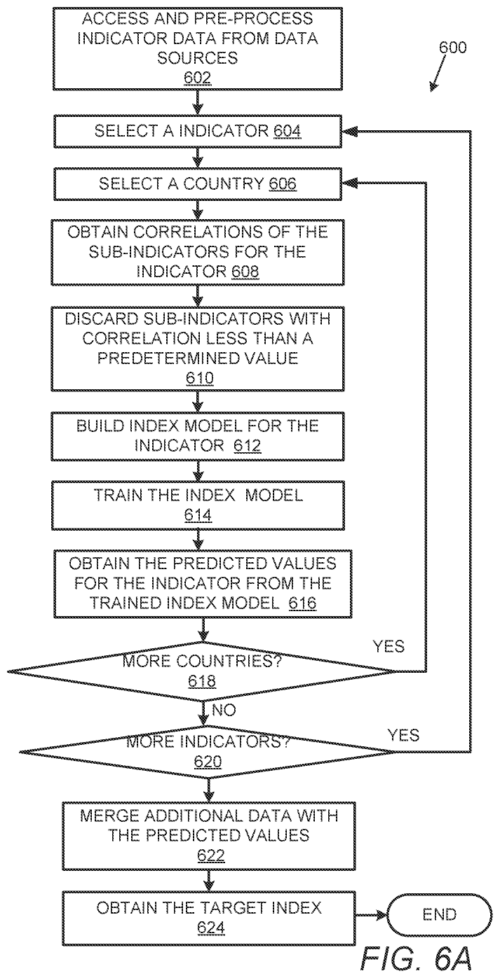

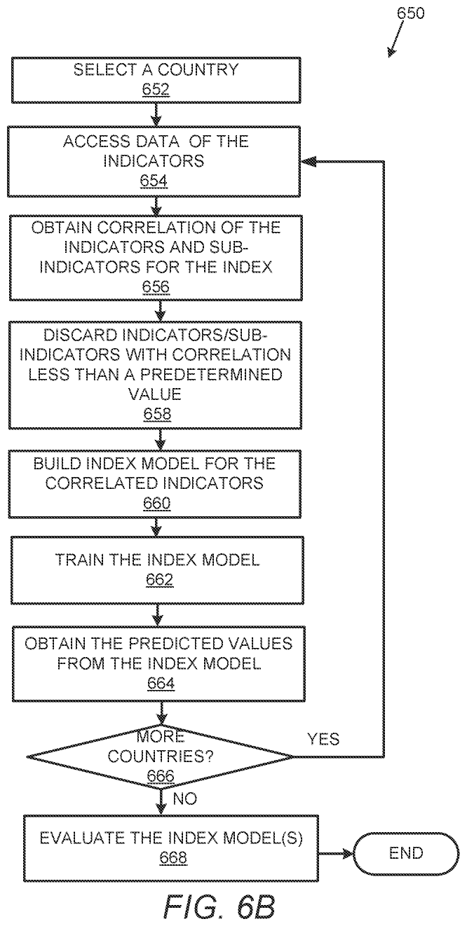

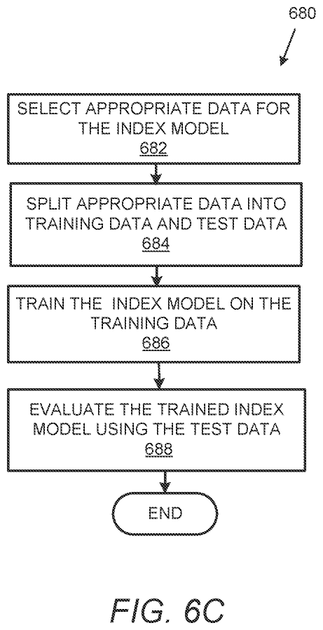

FIG. 6A shows a flowchart 600 of a process to obtain values or scores for an indicator (i.e., a supporting index) in accordance with the examples disclosed herein. For example, the method described in the flowchart 600 may be implemented by the model generator/trainer 104. The process of generating scores for a given index for values indicative of the corresponding attribute proceeds in two phases. In the first phase, the scores for the indicators which are used in calculating the index are obtained for a given commodity. In the second phase, the index values are obtained using the indicators. The flowchart 600 shows the steps executed for the first phase. One or more of the plurality of data sources 150 are initially accessed and pre-processed at 602. Data for one of the supporting indexes for one of the highest-level entities of the hierarchy (e.g., a country) is initially accessed. In an example, the indicator data 152 can be accessed from different data sources in different formats. The indicator data 152 relates to an index (e.g., CLI) and includes data pertaining to the multiple indicators and a plurality of sub-indicators of the index. In an example, the data from the different data sources may be retrieved in different formats and pre-processing includes checking data sufficiency criteria and dropping indicators that have more than 20% missing values. Data pre-processing can also involve converting the data of the remaining indicators from the different formats into a uniform format to generate the master file 252.

At 604, an indicator is selected, and at 606, a country is selected for obtaining the predicted values 162 for the index. At 608, the correlations of the various sub-indicators to the indicator are obtained. In an example, Pearson's correlation coefficient can be used. At 610, the sub-indicators with a correlation less than a certain predetermined value (e.g., less than 0.6) are discarded. At 612, an index model such as a multiple linear regression model is built with the indicator as the target variable and the sub-indicators as explanatory variables. At 614, the index model built with the target and the explanatory variables is trained on training data. At 616, the predicted values from the index model are obtained for the indicator. At 618, it is determined if more countries are to be processed for the indicator. If yes, the method returns to 606 to select the relevant data for the next country. At 620, it is further determined if another indicator remains to be processed. If yes, the method again returns to 604 for selecting the relevant indicator data including the sub-indicators for all the countries. If it is determined at 620 that no more indicators remain for processing, any additional data for obtaining the index is merged at 622 with the predicted supporting index obtained as detailed in the previous steps. At 624, the target index is obtained from the indicators as detailed infra.

FIG. 6B includes a flowchart 650 of a process to obtain the scores for the target index in accordance with the examples disclosed herein. At 652, an entity from the highest level entities of the hierarchy below the index (e.g., a country) is selected. At 654, data for the indicators of the country is accessed from the merged data obtained at 620. At 656, the correlations of the indicators and sub-indicators to the index for the selected country are obtained. In an example, Pearson's correlation coefficient can be used. At 658, the indicators and sub-indicators with correlations less than a certain predetermined value (e.g., less than 0.6) are discarded. At 660, an index model such as a multiple linear regression model is built with the index as the target variable and the filtered indicators/sub-indicators as explanatory variables. At 662, the index model is trained on training data selected from the indicator data 152. The training data can include values for the target index averaged from the indicators along with the correlated indicator values. At 664, the predicted values from the index model are obtained from the trained index model. At 666, it is determined if another country remains to be processed. If yes, the method returns to 654 to select the next country. Thus, respective index models are developed for different countries. Similarly, for each country different index models can be developed for entities lower down in the hierarchy from the country entity e.g., region-wise or supplier-wise provided the relevant entity data satisfies the data sufficiency requirements. If no further entities remain for processing at 666, the index model can be evaluated at 668 using methodologies such as RMSE with the test data. In an example, the index risk scores can be bucketed into different categories. For example, CLI index scores greater than 7.5 can be categorized as extreme, scores between 5-7.5 can be categorized as high, scores between 2.5-5 can be categorized as moderate, and index scores less than 2.5 can be categorized as low.

FIG. 6C shows a flowchart 680 of a method of training the index models 106, 106-1, 106-1-1, . . . 106-2, . . . , 106-n-m, in accordance with the examples disclosed herein. At 682, the appropriate data for a given index model is selected from the indicator data 152. In an example, if the index model is being trained to predict values for an index/indicator, then a subset of the indicator data 152 including the sub-indicator data for that index/indicator pertaining to all the entities in the hierarchy is selected at 682. However, if the index model is to be trained to predict values for an index/indicator for a specific entity, then another subset of the indicator data 152 including the sub-indicator data relevant to the entity is selected at 682. At 684, the appropriate data is split into training data and test data. At 686, the index model is trained on the training data and at 688, the trained model is tested/validated with the test data using methodologies such as but not limited to RMSE.

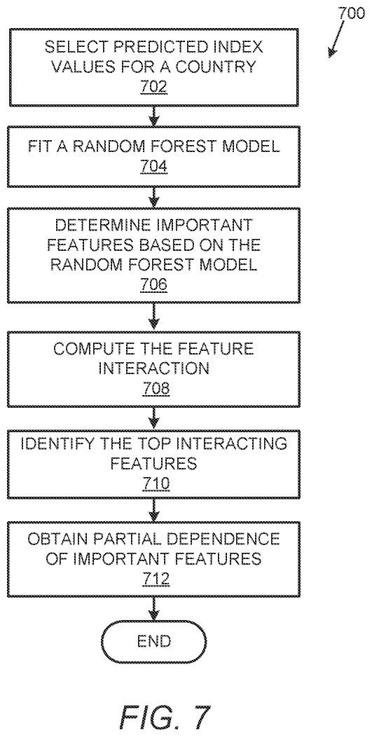

FIG. 7 shows a flowchart 700 that details a method of analyzing the outputs of the index models 106, 106-1, . . . , 106-n, in accordance with the examples disclosed herein. The method begins at 702 wherein the predicted values 162 of an index for a given commodity and country are selected. At 704, a random forest model is fitted keeping the index as the target variable and the remaining indicators/sub-indicators as features. For easy interpretation of the feature impact on the index, the random forest model was implemented. The mean squared residuals and the percentage variation is indicative of how well the model fits the data. The implementation of the random forest model provides important features at 706. The minimal depth for a variable/feature in a tree equals the depth of the node which splits on that variable and is the closest to the root of the tree. The smaller the mean minimal depth, the more important the variable. In an example, the features may be arranged in descending order of importance scores and top n (n is a natural number and n=1, 2, 3 . . . ) features can be identified as important features. At 708, the feature interaction can be computed using the minimal depth function. When features interact with each other in a prediction model, the predictions cannot be expressed as the sum of the feature effects. This is because the effect of one feature depends on the value of the other feature. The interaction strength can be estimated by measuring the extent of the variation of the prediction with the interaction of the features. At 710, the top interacting features affecting the index are identified based on the feature interaction. Furthermore, at 712, the partial dependence of the important features can be obtained, using, for example, a ‘partial’ function from a Partial Dependence Plots (PDP) package. Thus, the functional relationships between the index and the features of interest are analyzed. The method outlined above is repeated for various countries.

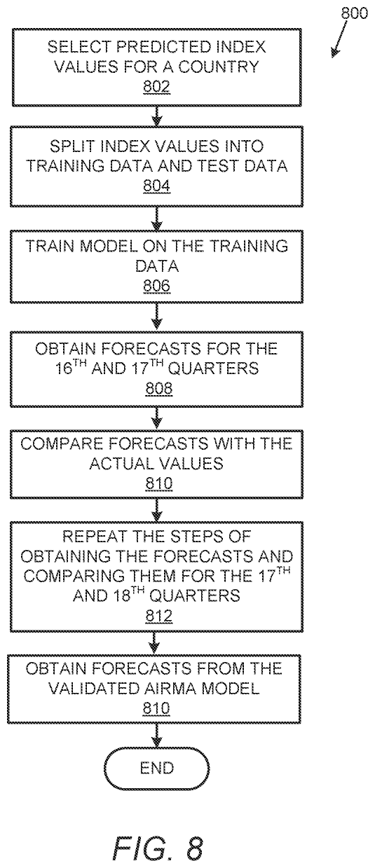

FIG. 8 shows a flowchart for obtaining forecasts for index values based on time series models in accordance with the examples disclosed herein. Obtaining future index values enables identifying suppliers who are on the verge of improving their status or those who are on the verge of being eliminated from the procurement process. Messages can be transmitted to the concerned suppliers or other stakeholders to whom such status changes may be relevant. At 802, the predicted index values are selected for an entity (country or supplier) for a specified time period (e.g., 18 quarters). At 804, the predicted index values can be split into training data and testing data. For example, data for the 15 quarters can be used as the training data while data for the 16^{th} and the 17^{th} quarters is used as the test data. At 806, an ARIMA model is trained on the training data and at 808, forecasts for the 16th and the 17^{th} quarters are obtained. At 810, the ARIMA model is tested by comparing the forecasted values for the 16th and 17^{th} quarters with the actual values. In an example, the RMSE between the forecasts and the actual values can be calculated. Similarly, the steps of obtaining forecasts and comparing them with the actual values are repeated for the 17^{th} and 18^{th} quarters at 812. At 814, the forecasts for the attribute of the supply chain are obtained from the ARIMA model which is validated at 810 and 812. In addition to generating forecasts, the time series models enable determining from the RMSE if the index model 106-1-1 has produced accurate predictions for the index.

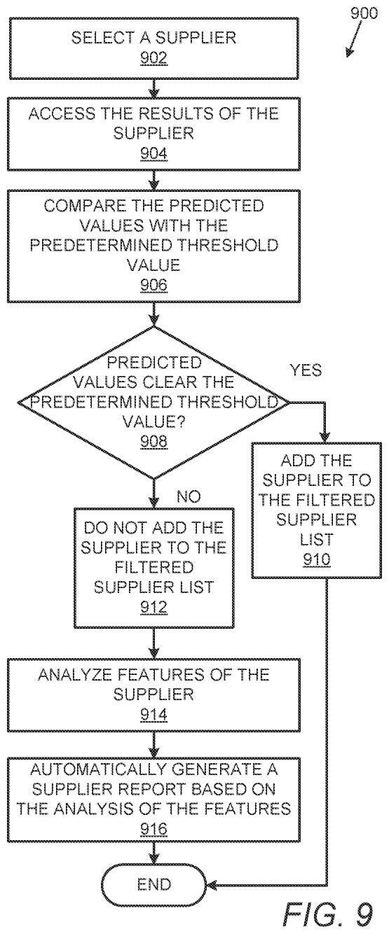

FIG. 9 shows a flowchart 900 of a method of identifying entities that do not meet thresholds for the various indexes and generating the filtered supplier list in accordance with the examples disclosed herein. At 902, a supplier is selected. At 904, a subset of the results 188 with the predicted index values 162 pertaining to the supplier is accessed. At 906, the predicted index values of the entity are compared to the predetermined threshold attribute value. It is determined at 908 if the predicted values of the supplier clear the predetermined threshold attribute value to automatically generate the filtered supplier list 142 in the supplier database 560. If yes, the supplier can be added to the filtered supplier list 142 at 910 and the supplier may be selectable for procurement within the material management system.

If it is determined at 908 that the predicted values of the supplier do not clear the predetermined threshold attribute value, the supplier will not be added to the filtered supplier list at 912. Accordingly, the supplier will not be selectable for procurement in the material management system. At 914, the features of the supplier are analyzed for generating the supplier report 550. For example, the important features are identified based on the feature importance scores 452 along with the top interacting features 454. At 916, the supplier report 550 outlining the failure of the supplier to meet the predetermined threshold attribute value can be generated to include the important features identified at 912 as areas for improvement or reasons for deletion.

### 4. User Interfaces

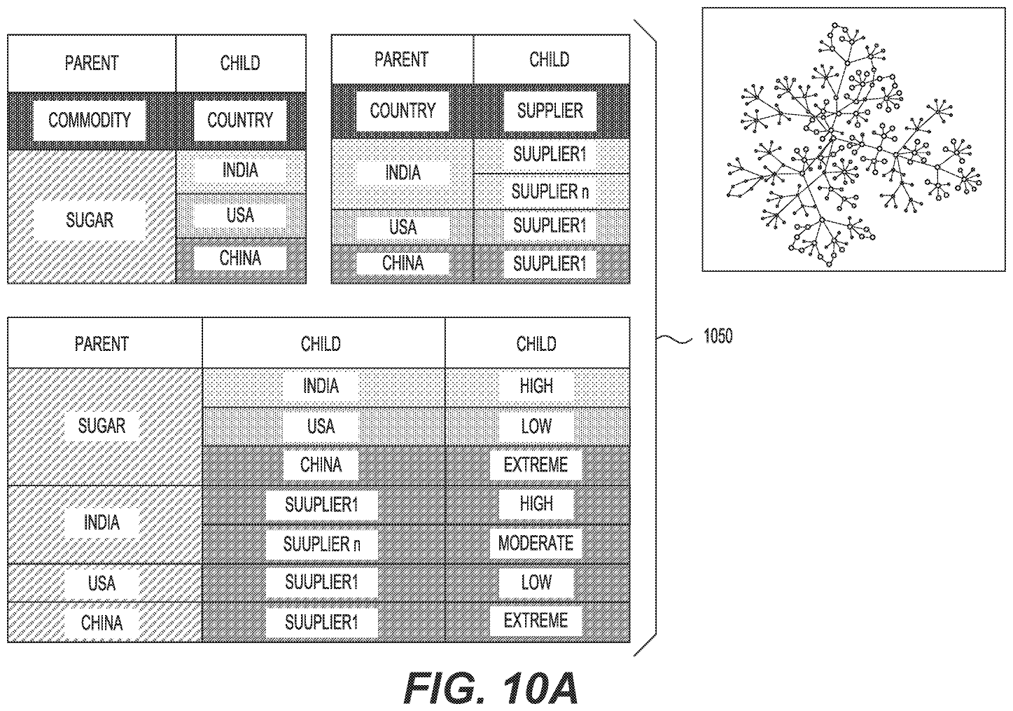

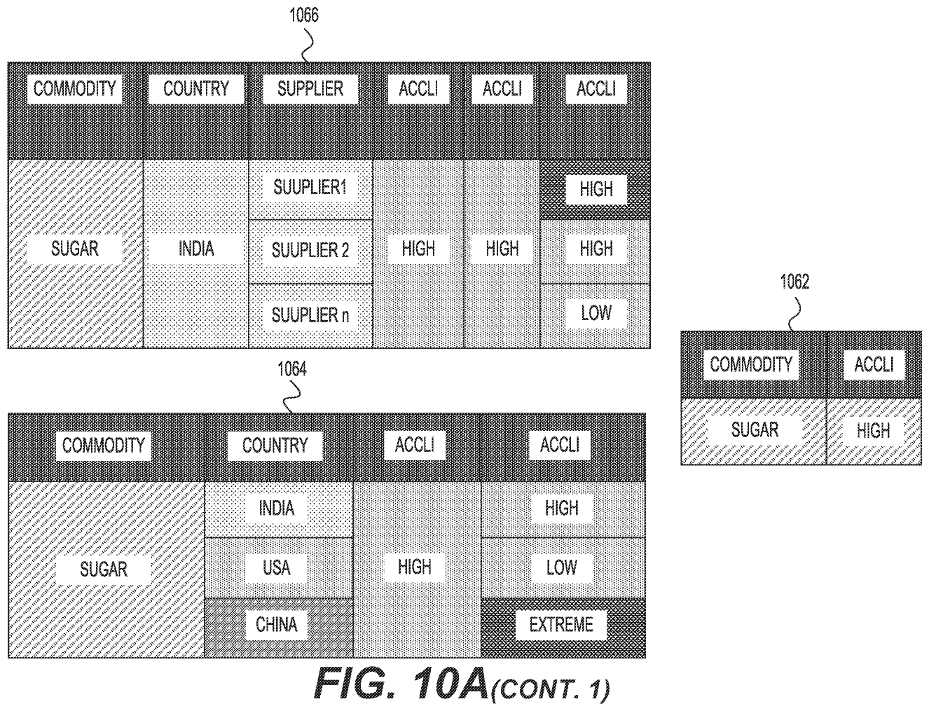

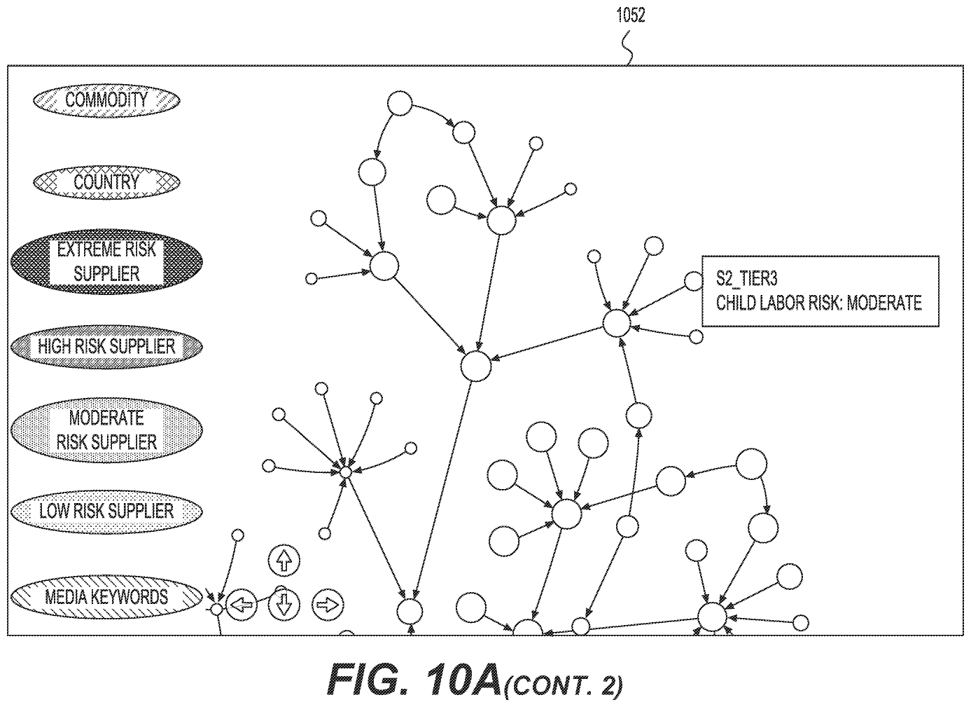

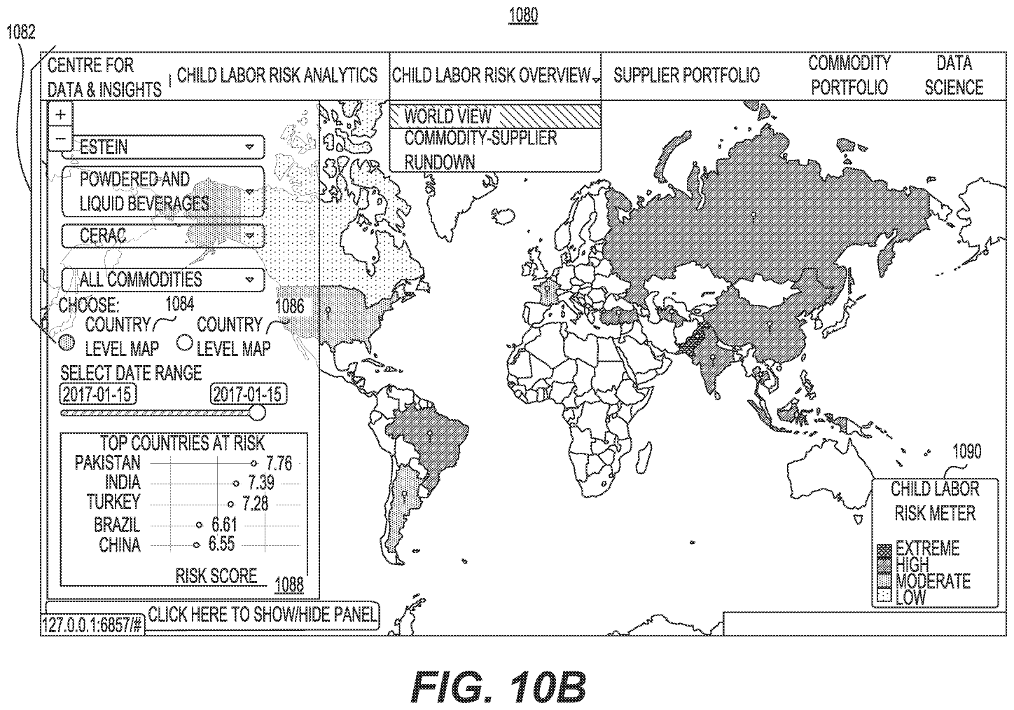

FIG. 10A shows some example insights that can be generated by the insight generator 108 in accordance with the examples disclosed herein. The insights may be displayed in the UIs provided by the GUI generator 112. Different data sets 1050 having established parent-child node relationships therebetween can be used. The node and edge data are passed to the visNetwork R function to generate a visualization of the network graph 1052. The network graph 1052 is created with the hierarchy as Commodity->Country->Supplier for the CLI. Various observations can be derived from the network graph 1052. For example, it can be observed from the table 1062 that the commodity ‘Sugar’ falls in the “High” category for child labor. The data can be further drilled down to countries for a detailed view to understand which countries are more prone to the risk of child labor. Another observation 1064 was made that India for sugar falls in the “High” category in terms of child labor risk. To identify the suppliers who contribute more toward child labor risk the CLI data can be drilled down to the supplier level as shown in table 1066. Easy representation of the journey from Commodity-Country-Supplier is thus enabled which helps to summarize/highlight important information. This information can be used within the material management system to automatically flag the high-risk suppliers who may be eliminated from the procurement process.

The insight generator 108 thus provides an in-depth view of data via the drill-down view of the entire supply chain. For any commodity, the risk pattern of the whole supply chain hierarchy can be displayed on one screen. The visualizations enable pinpointing child labor risk footprints in terms of commodities, countries, and suppliers. For commodities with a high risk of child labor, the nations and suppliers that contribute the most, as well as those with a low risk can be identified. Recurring patterns of child labor risk were observed across commodities and countries. A select group of suppliers displayed similar risk patterns. It was further observed from the visualizations that the risk across countries is independent of each other. Every country within a commodity has its own set of patterns. Since the risk indexes and macro-indicators were represented at the country level, the influence of factors on child labor risk for different countries can be further analyzed by the data analyzer 184 using techniques described herein. It was observed child labor risks for nations cluster among themselves and do not overlap suggesting non-independence within the risk score for a given country.

FIG. 10B shows a data visualization 1080 including a heat map 1082 generated in accordance with the examples disclosed herein. The GUI generator 112 can be configured to generate different data visualizations 122 including but not limited to various types of graphs, scatter plots, heat maps, etc. The legend 1090 enables interpreting the heat map 1082. The data visualization 1080 conveys at a single glance, the variation in the index values across the globe for the child labor attribute for a commodity, ‘Cerac’ used in the powdered and liquid beverage industry. This is indicated by the selection drop-down boxes 1082 which provide for examining the heat map 1080 at two different hierarchical levels, the country level 1084 and the supplier level 1086. In the heat map 1082, the country level 1084 is selected. Alternate graphical format 1088 is also included in the data visualization 1080 to convey the information wherein the countries are arranged in a defined order of predicted values for the child labor index.

### 4. System Diagram

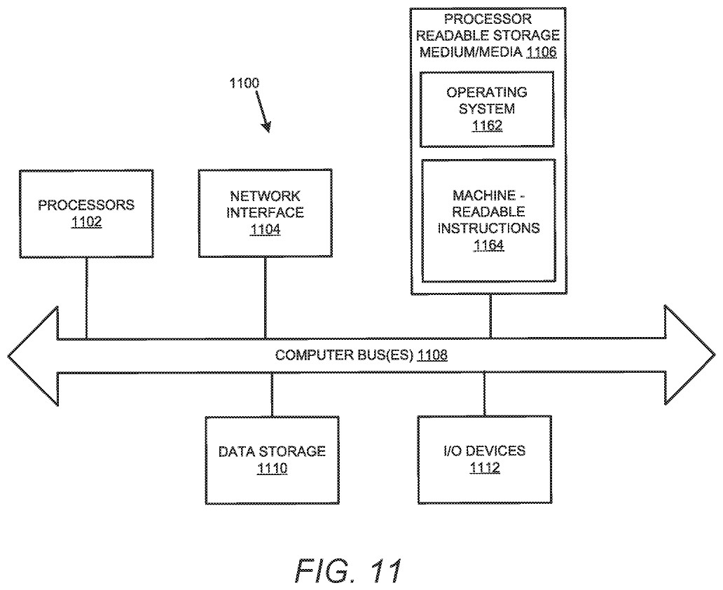

FIG. 11 illustrates a computer system 1100 that may be used to implement the index modeling system 100. More particularly, computing machines such as desktops, laptops, smartphones, tablets, and wearables which may be used to generate or access the data from the index modeling system 100 may have the structure of the computer system 1100. The computer system 1100 may include additional components not shown and that some of the process components described may be removed and/or modified. In another example, a computer system 1100 can sit on external-cloud platforms such as Amazon Web Services, AZURE® cloud or internal corporate cloud computing clusters, or organizational computing resources, etc.

The computer system 1100 includes processor(s) 1102, such as a central processing unit, ASIC or another type of processing circuit, input/output devices 1112, such as a display, mouse keyboard, etc., a network interface 1104, such as a Local Area Network (LAN), a wireless 802.11x LAN, a 3G, 4G or 5G mobile WAN or a WiMax WAN, and a computer-readable or processor-readable storage medium 1106. Each of these components may be operatively coupled to a bus 1108. The processor-readable medium 1106 may be any suitable medium that participates in providing instructions to the processor(s) 1102 for execution. For example, the processor-readable medium 1106 may be a non-volatile or non-transitory storage medium, such as a magnetic disk or solid-state non-volatile memory, or a volatile medium such as RAM. The instructions or modules stored on the processor-readable medium 1106 may include machine-readable instructions 1164 executed by the processor(s) 1102 that cause the processor(s) 1102 to perform the methods and functions of the index modeling system 100.

The index modeling system 100 may be implemented as software stored on a non-transitory processor-readable medium and executed by the one or more processors 1102. For example, the processor-readable medium 1106 may store an operating system 1162, such as MAC OS, MS WINDOWS, UNIX, or LINUX, and code or machine-readable instructions 1164 for the index modeling system 100. The operating system 1162 may be multi-user, multiprocessing, multitasking, multithreading, real-time, and the like. For example, during runtime, the operating system 1162 is running and the code for the index modeling system 100 is executed by the processor(s) 1102.

The computer system 1100 may include a data storage 1110, which may include non-volatile data storage. The data storage 1110 stores any data used by the indicator data 152, the results 188, the predicted index values 162, the various features and their importance scores, and other data that is used or generated by the index modeling system 100 during operation.

The network interface 1104 connects the computer system 1100 to internal systems for example, via a LAN. Also, the network interface 1104 may connect the computer system 1100 to the Internet. For example, computer system 1100 may connect to web browsers and other external applications and systems via the network interface 1104.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

What is claimed is:

1. An index modeling system, comprising:
at least one processor;
a non-transitory, processor-readable medium storing machine-readable instructions that cause the at least one processor to:
access from different data sources in different formats, indicator data of at least one index including data pertaining to multiple indicators and a plurality of sub-indicators of the multiple indicators,
wherein the at least one index is indicative of an attribute of a supply chain for a commodity,
wherein the indicator data includes a hierarchical structure of entities wherein at least one of the entities includes a supplier entity with a plurality of suppliers of the commodity;
convert the indicator data accessed from the different data sources into a uniform format;
store within a master file the indicator data converted into a uniform format;
build at least one index model with the at least one index as a target variable and one or more of the multiple indicators as explanatory variables;
train the at least one index model on the indicator data included in the master file,
wherein the at least one index model is trained for predicting values for the attribute;
obtain from the at least one trained index model, value predictions for the attribute of the supply chain,
wherein the attribute value predictions include the values predicted for at least the supplier entity;
automatically generate a filtered list of suppliers by omitting one or more of the plurality of suppliers that have the attribute value predictions less than a predetermined threshold attribute value;
transmit to a receiver, the filtered supplier list for procurement of the commodity.

2. The index modeling system of claim 1, wherein building the at least one index model further causes the at least one processor to:
select the one or more indicators based on correlations of the multiple indicators with the at least one index.

3. The index modeling system of claim 2, wherein building the at least one index model further causes the at least one processor to:
select, for each corresponding indicator of the one or more indicators, a subset of the plurality of sub-indicators based on correlations of the subset of plurality of sub-indicators with the corresponding indicator of the one or more indicators,
wherein the plurality of sub-indicators contribute to each of the multiple indicators.

4. The index modeling system of claim 3, wherein the correlation of the each of the one or more indicators with the at least one index is obtained using Pearson's Correlation coefficient.

5. The index modeling system of claim 3, wherein the correlations of the subsets of the plurality of sub-indicators for the one or more indicators are obtained using Pearson's Correlation coefficient.

6. The index modeling system of claim 3, wherein building the at least one index model further causes the at least one processor to:
build a respective index model for the at least one index for each country included in the master file.

7. The index modeling system of claim 1, wherein the at least one index model includes a multiple linear regression model.

8. The index modeling system of claim 1, wherein the non-transitory, processor-readable medium stores machine-readable instructions that further cause the at least one processor to:
provide reasons for deleting the one or more suppliers with the predicted attribute values less than the predetermined threshold attribute value.

9. The index modeling system of claim 8, wherein providing reasons for the deletion further causes the at least one processor to:
compute feature importance scores for the multiple indicators;
identify as important features, one or more of the multiple indicators based on a descending order of the feature importance scores; and
provide the important features as the reasons for the deletion.

10. The index modeling system of claim 9, wherein computing the feature importance scores further causes the at least one processor to:
compute the feature importance scores using a random forest model with the attribute as a target variable and the multiple indicators and the plurality of sub-indicators as features; and
identify important features from a descending order of the feature importance scores.

11. The index modeling system of claim 9, wherein the non-transitory, processor-readable medium stores machine-readable instructions that further cause the at least one processor to:
identify top interacting features from the important features, which together affect the attribute values of the at least one index.

12. The index modeling system of claim 11, wherein the non-transitory, processor-readable medium stores machine-readable instructions that further cause the at least one processor to:
calculate partial dependencies of the top interacting features on the at least one index.

13. The index modeling system of claim 9, wherein the non-transitory, processor-readable medium stores machine-readable instructions that further cause the at least one processor to:
quantify effects of the important features on the at least one index using quantile regression.

14. The index modeling system of claim 1, wherein the non-transitory, processor-readable medium stores machine-readable instructions that further cause the at least one processor to:
update a supplier database based at least on the filtered supplier list.

15. A method of generating a filtered list of entities comprising:
accessing from different data sources in different formats, indicator data of at least one index including data pertaining to multiple indicators and a plurality of sub-indicators of the multiple indicators,
wherein the at least one index is indicative of an attribute of a supply chain for a commodity,
wherein the indicator data includes a hierarchical structure of entities wherein at least one of the entities includes a supplier entity with a plurality of suppliers of the commodity;
converting the indicator data accessed from the different data sources into a uniform format;
storing within a master file the indicator data converted into a uniform format;
building at least one index model with the at least one index as a target variable and one or more of the multiple indicators as explanatory variables;
training the at least one index model on at least a selected subset of the indicator data included in the master file,
wherein the at least one index model is trained for predicting values for the attribute;
obtaining from the at least one trained index model, value predictions for the attribute of the supply chain,
wherein the attribute value predictions include the values predicted for at least the supplier entity;
automatically generating a filtered list of suppliers by omitting one or more of the plurality of suppliers that have the attribute value predictions less than a predetermined threshold attribute value; and
transmitting to a receiver, the filtered supplier list for procurement of the commodity.

16. The method of claim 15, wherein obtaining the predictions for the attribute values further comprises:
obtaining the predicted attribute values for the at least one index for a specified time period; and
splitting the predicted attribute values of the specified time period into training data and test data.

17. The method of claim 16, further comprising:
training an Auto Regressive Integrated Moving Average (ARIMA) model on the training data.
validating the ARIMA model using the test data; and
obtaining forecasts for the attribute of the supply chain from the validated ARIMA model.

18. The method of claim 16, wherein the hierarchical structure of entities includes commodity entity at a highest level, country entity at a mid-level, and the supplier entity at a lowest level of the hierarchical structure.

19. A non-transitory processor-readable storage medium comprising machine-readable instructions that cause a processor to:
access from different data sources in different formats, indicator data of at least one index including data pertaining to multiple indicators and a plurality of sub-indicators of the multiple indicators,
wherein the at least one index is indicative of an attribute of a supply chain for a commodity,
wherein the indicator data includes a hierarchical structure of entities wherein at least one of the entities includes a supplier entity with a plurality of suppliers of the commodity;
convert the indicator data accessed from the different data sources into a uniform format;
store within a master file the indicator data converted into a uniform format;
build at least one index model with the at least one index as a target variable and one or more of the multiple indicators as explanatory variables;
train the at least one index model on the indicator data included in the master file,
wherein the at least one index model is trained for predicting values for the attribute;
obtain from the at least one trained index model, value predictions for the attribute of the supply chain,
wherein the attribute value predictions include the values predicted for at least the supplier entity;
automatically generate a filtered list of suppliers by omitting one or more of the plurality of suppliers that have the attribute value predictions less than a predetermined threshold attribute value; and
transmit to a receiver, the filtered supplier list for procurement of the commodity.

20. The non-transitory processor-readable storage medium of claim 19, further comprising instructions that cause the processor to:
receive a user request related to the attribute values predictions of the at least one index; and
responsive to the user request, display a heat map showing a distribution of the attribute value predictions for the commodity across the globe.
